(19) United States
(12) Patent Application Publication
(10) Pub. No.: US 2017/0365420 A1
(43) Pub. Date: Dec. 21, 2017

(54) ELECTRIC DOUBLE-LAYER CAPACITOR

(71) Applicant: Murata Manufacturing Co., Ltd., Nagaokakyo-shi (JP)

(72) Inventors: KEIJI HORIKAWA, Nagaokakyo-shi (JP); Iwao Kurimoto, Nagaokakyo-shi (JP); Takayuki Hata, Nagaokakyo-shi (JP)

(21) Appl. No.: 15/693,595

(22) Filed: Sep. 1, 2017

Related U.S. Application Data
(63) Continuation of application No. PCT/JP2016/053862, filed on Feb. 9, 2016.

(30) Foreign Application Priority Data
Mar. 5, 2015 (JP) 2015-044112

(51) Int. Cl. H01G 11/28; H01G 11/52; H01G 11/74; H01G 11/56; H01G 11/30; H01G 11/62

(52) U.S. Cl. CPC H01G 11/28; H01G 11/52; H01G 11/74; H01G 11/30; H01G 11/62; H01G 11/56

(57) ABSTRACT

An electric double-layer capacitor that includes a positive electrode, a negative electrode, and an electrolyte. The positive electrode includes a positive-electrode collector electrode and a positive-electrode polarizable electrode on the positive-electrode collector electrode. The negative electrode includes a negative-electrode collector electrode and a negative-electrode polarizable electrode on the negative-electrode collector electrode. The negative electrode faces the positive electrode. The electrolyte is interposed between the positive electrode and the negative electrode. A separator is provided between the positive-electrode polarizable electrode and the negative-electrode polarizable electrode adjacent to each other. No polarizable electrode is provided on an outer surface of the collector electrode of each one of the positive electrode and the negative electrode positioned outermost in a thickness direction of the electric double-layer capacitor.

### CROSS REFERENCE TO RELATED APPLICATIONS

The present application is a continuation of International application No. PCT/JP2016/053862, filed Feb. 9, 2016, which claims priority to Japanese Patent Application No. 2015-044112, filed Mar. 5, 2015, the entire contents of each of which are incorporated herein by reference.

### FIELD OF THE INVENTION

The present invention relates to an electric double-layer capacitor.

### BACKGROUND OF THE INVENTION

Conventionally, capacitors have been widely used in various kinds of electronic devices such as cellular phones. Examples of known capacitors include an electric double-layer capacitor (EDLC). The electric double-layer capacitor involves no chemical reaction at charging and discharging unlike a secondary battery, and thus advantageously has a long product lifetime and can complete charging and discharging in a short time with a large current. For this reason, the electric double-layer capacitor has been tested for application in, for example, usage requiring a long product lifetime and usage requiring a large current.

Patent Document 1 discloses an exemplary electric double-layer capacitor. In the electric double-layer capacitor disclosed in Patent Document 1, a separator is provided to cover a negative electrode, and accordingly, separate the negative electrode from a positive electrode.

Patent Document 1: Japanese Patent Application Laid-open No. 2014-63789

### SUMMARY OF THE INVENTION

It is a continual requirement to reduce the thickness of electric double-layer capacitors.

The present invention is mainly intended to provide a thin electric double-layer capacitor.

An electric double-layer capacitor according to an embodiment of the present invention includes a positive electrode, a negative electrode, an electrolyte, and a separator. The positive electrode includes a positive-electrode collector electrode and a positive-electrode polarizable electrode. The positive-electrode polarizable electrode is provided on the positive-electrode collector electrode. The negative electrode includes a negative-electrode collector electrode and a negative-electrode polarizable electrode. The negative-electrode polarizable electrode is provided on the negative-electrode collector electrode. The negative electrode faces to the positive electrode. The electrolyte is interposed between the positive electrode and the negative electrode. The separator is provided between the positive-electrode polarizable electrode and the negative-electrode polarizable electrode which oppose each other. The separator has a flat plate shape. No polarizable electrode is provided on an outer surface of the collector electrode of each one of the positive electrode and the negative electrode, which are positioned outermost in a thickness direction. Since, in the electric double-layer capacitor according to the present embodiment, the separator has a flat plate shape, and no polarizable electrode is provided on the outer surface of the collector electrode of each one of the positive electrode and the negative electrode, which is positioned outermost in the thickness direction, the electric double-layer capacitor can have a reduced thickness.

Preferably, the separator is larger than the positive electrode and the negative electrode, and the electric double-layer capacitor further includes a bonding layer that bonds peripheral parts of the separators to at least one of the positive electrode and the negative electrode.

It is also preferable that at least one of the positive electrode and the negative electrode includes a facing part which faces the other of the positive electrode and the negative electrode, and an outside part positioned outside the facing part, and the electric double-layer capacitor further includes a bonding layer that bonds the outside part and the peripheral part of the separator.

Preferably, the bonding layer is separated from the facing part in which the positive electrode and the negative electrode face to each other and does not extend into the facing part. In this case, blockage of pores in a portion of the separator, which is positioned on the facing part in which the positive electrode and the negative electrode face to each other, is unlikely to occur due to a bonding agent applied for forming the bonding layer. This configuration can prevent reduction of the capacitance of the electric double-layer capacitor.

It is preferable that the porosity of at least part of a portion of the separator, which is positioned between the bonding layer and the facing part in plan view, is lower than the porosity of a portion of the separator positioned on the facing part in plan view. In this case, blockage of pores in a portion of the separator, which is positioned on the facing part in which the positive electrode and the negative electrode face each other, is unlikely to occur due to a bonding agent applied to form the bonding layer and having reached at this portion in plan view. This configuration can prevent reduction of the capacitance of the electric double-layer capacitor.

The thickness of a portion of the separator, which is positioned between the bonding layer and the facing part in plan view, is preferably smaller than the thickness of a portion of the separator positioned on the facing part in plan view. In this case, blockage of pores in a portion of the separator, which is positioned on the facing part in which the positive electrode and the negative electrode face to each other, is unlikely to occur due to a bonding agent applied to form the bonding layer and having reached at this portion in plan view. This configuration can prevent reduction of the capacitance of the electric double-layer capacitor.

The positive electrode preferably includes a positive-electrode facing part that faces the negative electrode, a positive-electrode terminal part connected with the positive-electrode facing part and extending outward from the positive-electrode facing part in a first direction, and a positive-electrode outside part connected with the positive-electrode facing part and extending toward a side opposite to the positive-electrode terminal part in the first direction. The negative electrode preferably includes a negative-electrode facing part that faces the positive electrode, a negative-electrode terminal part connected with the negative-electrode facing part and extending in the first direction, and a negative-electrode outside part connected with the negative-electrode terminal part and extending toward a side opposite to the negative-electrode terminal part in the first direction. In this case, it is preferable that the positive-electrode terminal part and the negative-electrode terminal part are disposed without overlapping each other in plan view, the positive-electrode outside part and the negative-electrode outside part are disposed without overlapping each other in plan view, and the positive-electrode terminal part, the negative-electrode terminal part, the positive-electrode outside part, and the negative-electrode outside part are bonded with the bonding layer. This configuration leads to further improvement of the bonding strength of a laminated body including the separator, the positive electrode, and the negative electrode.

The present invention provides a thin electric double-layer capacitor.

### BRIEF EXPLANATION OF THE DRAWINGS

FIG. 1 is a schematic cross-sectional view of an electric double-layer capacitor according to an embodiment of the present invention.

FIG. 2 is a schematic plan view of the electric double-layer capacitor according to the embodiment of the present invention.

FIG. 3 is a schematic plan view of a negative electrode in the embodiment of the present invention.

FIG. 4 is a schematic plan view of a positive electrode in the embodiment of the present invention.

### DETAILED DESCRIPTION OF PREFERRED EMBODIMENTS OF THE INVENTION

A preferred embodiment of the present invention will be described below. However, the embodiment described below is merely exemplary. The present invention is not limited by the embodiment described below.

Any drawing to be referred in the embodiments and the like is schematically illustrated. The dimensional ratio and the like of an object illustrated in the drawing are different from the dimensional ratio and the like of the real object in some cases. The dimensional ratio and the like of an object are different between the drawings in some cases. The specific dimensional ratio and the like of an object are to be determined based on the following description.

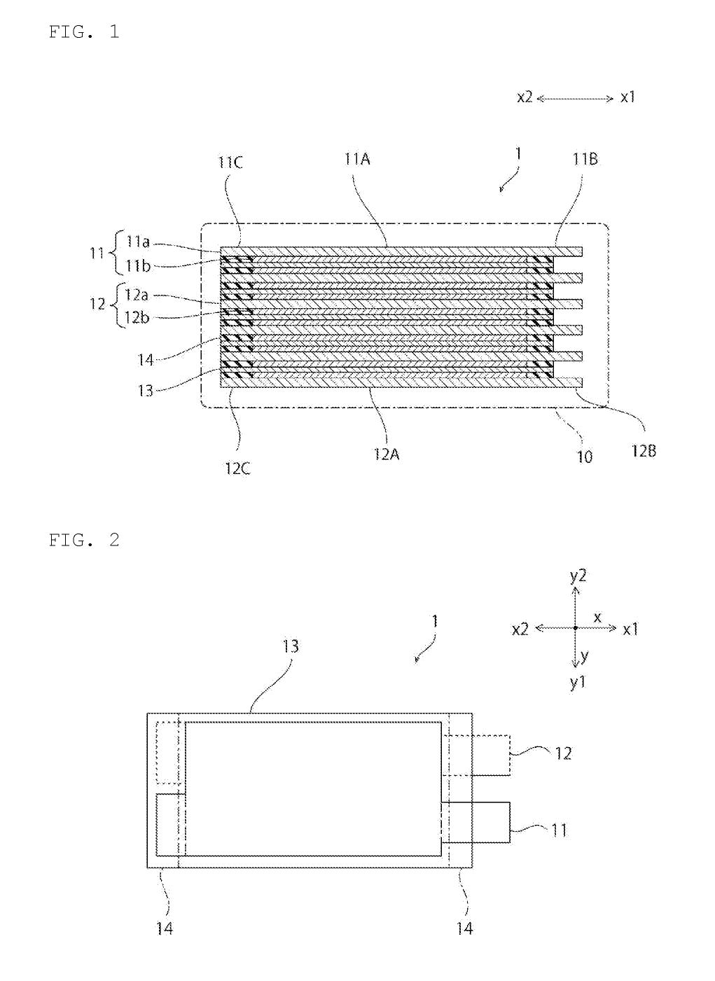

FIG. 1 is a schematic cross-sectional view of an electric double-layer capacitor according to the present embodiment.

FIG. 2 is a schematic plan view of the electric double-layer capacitor according to the present embodiment. FIG. 2 omits illustration of an exterior body 10.

As illustrated in FIG. 1, this electric double-layer capacitor 1 includes a negative electrode 11, a positive electrode 12, a separator 13, a bonding layer 14, and the exterior body 10.

The negative electrode 11 and the positive electrode 12 face to each other with the separator 13 interposed therebetween. Specifically, a plurality of the negative electrodes 11 and a plurality of the positive electrodes 12 are alternately laminated with the separator 13 interposed therebetween. Each negative electrode 11 is electrically connected with a negative-electrode wiring member (not illustrated) and extended out of the exterior body 10. Each positive electrode 12 is electrically connected with a positive-electrode wiring member (not illustrated) and extended out of the exterior body 10.

### Negative Electrode 11

Each negative electrode 11 includes a negative-electrode collector electrode 11a. The negative-electrode collector electrode 11a may be formed of, for example, aluminum foil. The negative-electrode collector electrode 11a may have a thickness of, for example, 10 μm to 30 μm approximately.

A negative-electrode polarizable electrode 11b is provided on each negative-electrode collector electrode 11a. Specifically, the negative-electrode collector electrode 11a positioned outermost in a thickness direction (lamination direction) among the positive electrodes 12 and the negative electrodes 11 is provided with the negative-electrode polarizable electrode 11b only on an inner principal surface but not on an outer principal surface. The negative-electrode polarizable electrodes 11b of the other negative electrodes 11 are provided on both principal surfaces of the negative-electrode collector electrodes 11a. In other words, each negative-electrode polarizable electrode 11b is provided only on one of the principal surfaces of the corresponding negative-electrode collector electrode 11a, which faces to the positive electrode 12. The negative-electrode polarizable electrode 11b may have a thickness of, for example, 10 μm to 30 μm approximately.

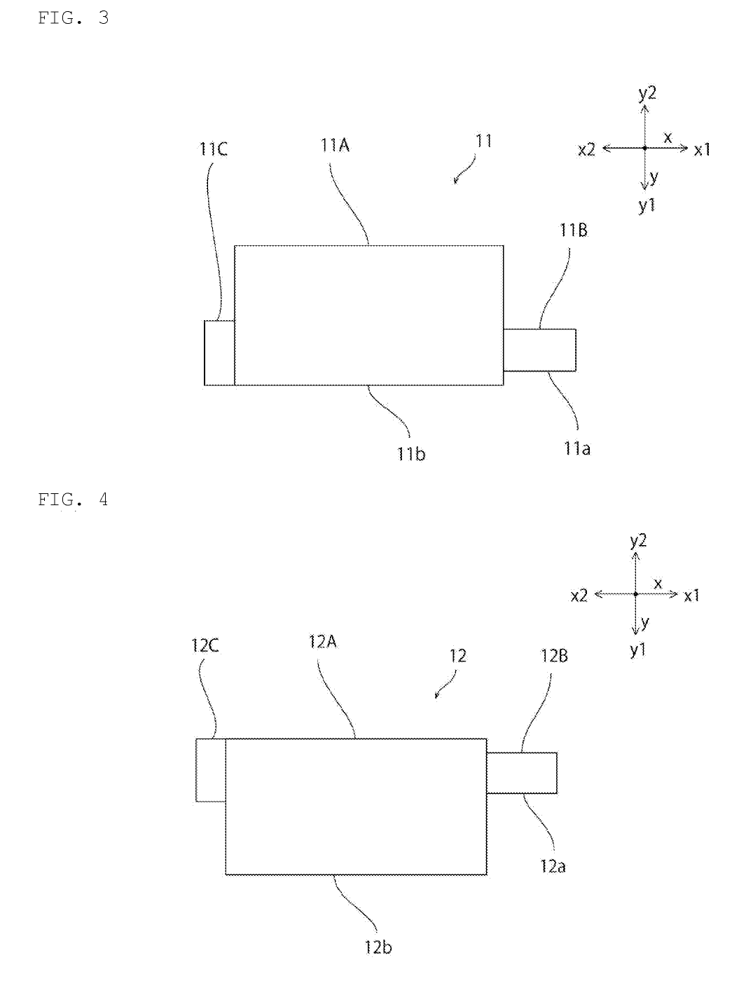

As illustrated in FIGS. 1 and 3, each negative electrode 11 includes a negative-electrode facing part 11A, a negative-electrode terminal part 11B, and a negative-electrode outside part 11C. The negative-electrode facing part 11A faces to the positive electrode 12. The negative-electrode terminal part 11B is connected with the negative-electrode facing part 11A. Specifically, in the present embodiment, the negative-electrode terminal part 11B extends toward an x1 side from a portion of the negative-electrode facing part 11A on a y1 side in a y-axis direction orthogonal to an x-axis direction. The negative-electrode outside part 11C is connected with the negative-electrode facing part 11A. The negative-electrode outside part 11C extends from the negative-electrode facing part 11A toward an x2 side in the x-axis direction. Specifically, in the present embodiment, the negative-electrode outside part 11C extends toward the x2 side from a portion of the negative-electrode facing part 11A on a y1 side in the y-axis direction. The negative-electrode polarizable electrode 11b is provided only to the negative-electrode facing part 11A but not to the negative-electrode terminal part 11B nor the negative-electrode outside part 11C. The negative-electrode terminal part 11B and the negative-electrode outside part 11C are parts of the negative-electrode collector electrode 11a.

### Positive Electrode 12

Each positive electrode 12 includes a positive-electrode collector electrode 12a. The positive-electrode collector electrode 12a may be formed of, for example, aluminum foil. The positive-electrode collector electrode 12a may have a thickness of, for example, 10 μm to 30 μm approximately.

A positive-electrode polarizable electrode 12b is provided on each positive-electrode collector electrode 12a. Specifically, the positive-electrode collector electrode 12a positioned outermost in the thickness direction (lamination direction) among the positive electrodes 12 and the negative electrodes 11 is provided with the positive-electrode polarizable electrode 12b only on an inner principal surface but not on an outer principal surface. The positive-electrode polarizable electrodes 12b of the other positive electrodes 12 are provided on both principal surfaces of the positive-electrode collector electrodes 12a. In other words, each positive-electrode polarizable electrode 12b is provided only on one of the principal surface of the corresponding positive-electrode collector electrode 12a, which faces to the negative electrode 11. The positive-electrode polarizable electrode 12b may have a thickness of, for example, 10 μm to 30 μm approximately.

As illustrated in FIGS. 1 and 4, the positive electrode 12 includes a positive-electrode facing part 12A, a positive-electrode terminal part 12B, and a positive-electrode outside part 12C. The positive-electrode facing part 12A faces to the negative electrode 11. The positive-electrode terminal part 12B is connected with the positive-electrode facing part 12A. Specifically, in the present embodiment, the positive-electrode terminal part 12B extends toward the x1 side from a portion of the positive-electrode facing part 12A on the y2 side in the y-axis direction. The positive-electrode outside part 12C is connected with the positive-electrode facing part 12A. The positive-electrode outside part 12C extends from the positive-electrode facing part 12A toward the x2 side in the x-axis direction. Specifically, in the present embodiment, the positive-electrode outside part 12C extends toward the x2 side from a portion of the positive-electrode facing part 12A on the y2 side in the y-axis direction. The positive-electrode polarizable electrode 12b is provided only to the positive-electrode facing part 12A but not to the positive-electrode terminal part 12B nor the positive-electrode outside part 12C. The positive-electrode terminal part 12B and the positive-electrode outside part 12C are parts of the positive-electrode collector electrode 12a.

### Separator 13

Each separator 13 is provided between the corresponding negative and positive electrodes 11 and 12 adjacent to each other. The separator 13 has a flat plate shape larger than the negative electrode 11 and the positive electrode 12. The separator 13 separates the negative electrode 11 and the positive electrode 12 from each other. Specifically, the separator 13 is interposed between the negative-electrode polarizable electrodes 11b of the negative electrodes 11 and the positive-electrode polarizable electrodes 12b of the positive electrodes 12. The separator 13 may be formed of, for example, a porous sheet including a plurality of open cells.

### Exterior Body 10

The negative electrode 11, the positive electrode 12, and the separator 13 are housed in the exterior body 10. The negative electrode 11 and the positive electrode 12 are connected with a negative-electrode extended terminal (not illustrated) and a positive-electrode extended terminal (not illustrated), respectively, provided outside the exterior body 10. The exterior body 10 may be formed of, for example, an aluminum laminate, both surfaces of which are covered by resin layers.

### Electrolyte

The exterior body 10 is filled with an electrolyte. The electrolyte is interposed between the negative electrodes 11 and the positive electrodes 12. Specifically, the electrolyte is interposed between the negative-electrode polarizable electrodes 11b of the negative electrodes 11 and the positive-electrode polarizable electrodes 12b of the positive electrodes 12 via the separator 13.

The electrolyte includes a cation, an anion, and a solvent. Examples of preferable cations include tetraethylammonium salt. Examples of preferable anions include tetrafluoroborate ion (BF⁴⁻) and bis (trifluoromethylsulfonyl) imide ((CF₃SO₂)₂N⁻). Examples of preferable solvents include an aqueous solvent of carbonate compounds such as propylene carbonate, ethylene carbonate, diethyl carbonate, dimethyl carbonate, nitrile compound, and water.

The electrolyte may be, for example, a crosslinkable gel electrolyte or ionic liquid made of an imidazole compound.

### Bonding Layer 14

As illustrated in FIGS. 1 and 2, each bonding layer 14 is provided to bond peripheral parts of the separators 13 adjacent to each other in the thickness direction with one of the negative and positive electrodes 11 and 12 interposed therebetween. In the present invention, the bonding layer may bond any separator with the outside part of one of the negative and positive electrodes.

The bonding layers 14 are provided outside the facing parts 11A and 12A in the x-axis direction. The bonding layers 14 are separated from the facing parts 11A and 12A in the x-axis direction and do not extend into the facing parts 11A and 12A. With this configuration, a bonding agent for forming the bonding layers 14 can be effectively prevented from entering into the separator 13 and filling voids in a portion of the separator 13, which is positioned between the facing parts 11A and 12A. Thus, the capacitance of the electric double-layer capacitor 1 can be prevented from decreasing.

To effectively prevent the bonding agent that forms the bonding layer 14 from entering into the separator 13 and filling voids in the portion of the separator 13 which is positioned between the facing parts 11A and 12A, it is preferable that the porosity of at least part of a portion of the separator 13, which is positioned between the bonding layer 14 and each of the facing parts 11A and 12A in plan view, is lower than the porosity of a portion of the separator 13 positioned on each of the facing parts 11A and 12A in plan view. It is preferable that the porosity of at least part of the portion of the separator 13, which is positioned between the bonding layer 14 and each of the facing parts 11A and 12A in plan view is substantially zero. From the same viewpoint, it is preferable that the thickness of the portion of the separator 13, which is positioned between the bonding layer 14 and each of the facing parts 11A and 12A is smaller than the thickness of the portion of the separator 13, which is positioned on each of the facing parts 11A and 12A. In these cases, the bonding agent applied on the separator 13 is unlikely to reach at the portion of the separator 13, which is positioned on each of the facing parts 11A and 12A through the portion of the separator 13, which is positioned between the bonding layer 14 and each of the facing parts 11A and 12A. For this reason, in the present embodiment, the terminal parts 11B and 12B and the outside parts 11C and 12C are provided in regions in which the bonding layers 14 are provided. The terminal parts 11B and 12B and the outside parts 11C and 12C, which are not porous bodies, each have a high strength of bonding with the bonding layer 14. Thus, each component can be effectively prevented from peeling off.

To more effectively prevent each component from peeling off, it is preferable that the positive-electrode terminal part 12B and the negative-electrode terminal part 11B are disposed without overlapping in plan view, the positive-electrode outside part 12C and the negative-electrode outside part 11C are disposed without overlapping in plan view, and the positive-electrode terminal part 12B, the negative-electrode terminal part 11B, the positive-electrode outside part 12C, and the negative-electrode outside part 11C are bonded with the bonding layer 14.

When a bent-type separator is employed as in the electric double-layer capacitor disclosed in Patent Document 1, the electric double-layer capacitor is likely to have a large thickness due to the elasticity of the separator. In the electric double-layer capacitor 1 according to the present embodiment, however, the separator 13 having a flat plate shape is employed. In addition, no polarizable electrodes 11b and 12b are provided on the outer surfaces of the collector electrodes 11a and 12a of electrodes positioned outermost in the thickness direction among the positive electrodes 12 and the negative electrodes 11. This configuration leads to the electric double-layer capacitor 1 having a small thickness.

### DESCRIPTION OF REFERENCE SYMBOLS

1: electric double-layer capacitor
10: exterior body
11: negative electrode
11a: negative-electrode collector electrode
11b: negative-electrode polarizable electrode
11A: negative-electrode facing part
11B: negative-electrode terminal part
11C: negative-electrode outside part
12: positive electrode
12a: positive-electrode collector electrode
12b: positive-electrode polarizable electrode
12A: positive-electrode facing part
12B: positive-electrode terminal part
12C: positive-electrode outside part
13: separator
14: bonding layer

1. An electric double-layer capacitor comprising:
a positive electrode including a positive-electrode collector electrode and a positive-electrode polarizable electrode provided on the positive-electrode collector electrode;
a negative electrode including a negative-electrode collector electrode and a negative-electrode polarizable electrode provided on the negative-electrode collector electrode, the negative electrode facing the positive electrode such that the positive-electrode polarizable electrode and the negative-electrode polarizable electrode oppose each other;
an electrolyte interposed between the positive electrode and the negative electrode; and
a flat, plate-shaped separator between the positive-electrode polarizable electrode and the negative-electrode polarizable electrode,
wherein, in a thickness direction of the electric double-layer capacitor, an outermost electrode of either the positive electrode or the negative electrode does not have the polarizable electrode on an outer surface of either the positive-electrode collector electrode or the negative-electrode collector electrode.

2. The electric double-layer capacitor according to claim 1, wherein the separator is larger than the positive electrode and the negative electrode.

3. The electric double-layer capacitor according to claim 2, further comprising a bonding layer that bonds peripheral parts of the separator to at least one of the positive electrode and the negative electrode.

4. The electric double-layer capacitor according to claim 1, further comprising a bonding layer that bonds the separator to at least one of the positive electrode and the negative electrode.

5. The electric double-layer capacitor according to claim 3, wherein the at least one of the positive electrode and the negative electrode includes a facing part that faces the other of the positive electrode and the negative electrode, and an outside part positioned outside the facing part, and the bonding layer bonds the outside part to the peripheral part of the separator.

6. The electric double-layer capacitor according to claim 3, wherein the bonding layer does not extend into the facing part.

7. The electric double-layer capacitor according to claim 5, wherein a first porosity of at least part of a portion of the separator positioned between the bonding layer and the facing part in a plan view of the electric double-layer capacitor is lower than a second porosity of a portion of the separator positioned on the facing part in the plan view.

8. The electric double-layer capacitor according to claim 5, wherein a first thickness of a portion of the separator positioned between the bonding layer and the facing part in a plan view of the electric double-layer capacitor is smaller than a second thickness of a portion of the separator positioned on the facing part in the plan view.

9. The electric double-layer capacitor according to claim 3, wherein
the positive electrode includes:
a positive-electrode facing part that faces the negative electrode;
a positive-electrode terminal part connected with the positive-electrode facing part and extending outward from the positive-electrode facing part in a first direction; and
a positive-electrode outside part connected with the positive-electrode facing part and extending toward a side opposite to the positive-electrode terminal part in the first direction,
the negative electrode includes:
a negative-electrode facing part that faces the positive electrode;
a negative-electrode terminal part connected with the negative-electrode facing part and extending in the first direction; and
a negative-electrode outside part connected with the negative-electrode terminal part and extending toward a side opposite to the negative-electrode terminal part in the first direction, and
the positive-electrode terminal part and the negative-electrode terminal part are disposed so as to not overlap in a plan view of the electric double-layer capacitor, the positive-electrode outside part and the negative-electrode outside part are disposed so as to not overlap in the plan view, and the positive-electrode terminal part, the negative-electrode terminal part, the positive-electrode outside part, and the negative-electrode outside part are bonded with the bonding layer.

10. The electric double-layer capacitor according to claim 4, wherein
the positive electrode includes:
a positive-electrode facing part that faces the negative electrode;
a positive-electrode terminal part connected with the positive-electrode facing part and extending outward from the positive-electrode facing part in a first direction; and
a positive-electrode outside part connected with the positive-electrode facing part and extending toward a side opposite to the positive-electrode terminal part in the first direction,
the negative electrode includes:
a negative-electrode facing part that faces the positive electrode;
a negative-electrode terminal part connected with the negative-electrode facing part and extending in the first direction; and
a negative-electrode outside part connected with the negative-electrode terminal part and extending toward a side opposite to the negative-electrode terminal part in the first direction, and
the positive-electrode terminal part and the negative-electrode terminal part are disposed so as to not overlap in a plan view of the electric double-layer capacitor, the positive-electrode outside part and the negative-electrode outside part are disposed so as to not overlap in the plan view, and the positive-electrode terminal part, the negative-electrode terminal part, the positive-electrode outside part, and the negative-electrode outside part are bonded with the bonding layer.
